(19) United States
(12) Patent Application Publication
(10) Pub. No.: US 2003/0060997 A1
(43) Pub. Date: Mar. 27, 2003

(54) Seat belt force or tension sensor with programmable hall effect sensor

(76) Inventor: Timothy J. Ilyes, Lakeland, FL (US)

Correspondence Address: BREED TECHNOLOGIES, INC, PATENT DEPARTMENT, 7000 NINETEEN MILE ROAD, STERLING HEIGHTS, MI, 48314

(21) Appl. No.: 09/892,826

(22) Filed: Jun. 27, 2001

(51) Int. Cl. G06M 11/04

(52) U.S. Cl. 702/127

(57) ABSTRACT

A tension sensor comprising:

relatively movable first and second pieces, the pieces movable between a first position to a second position, at least one of the pieces operatively connected to a seat belt;

a spring for biasing the first and second pieces to the first position;

a magnet located on and movable with one of the first and second pieces, the magnet generating a magnetic field;

a magnetic means responsive to changes in the magnetic field resulting from the relative motion of the pieces for generating an output signal indicative thereof;

a compensator or programmable element for compensating for variances in the spring and magnet from respective nominal operating parameters for causing the output signal to follow a desired signature irrespective of the variances of the spring and magnet.

### BACKGROUND AND SUMMARY OF THE INVENTION

The present invention relates to a force (or tension) sensor and more particularly to a seat belt force sensor.

The invention generally relates to an improvement in seat belt force sensors of the type shown in U.S. Pat. No. 6,081,759. This class of force sensor comprises a housing, a sliding plate, a spring, various spacers, a magnet, and a stationary magnetic sensor. Alternatively, the magnet can be stationary and the magnetic sensor movable. The output from the magnetic sensor is an electronic signal that is proportional to the sensed magnetic field as the sliding plate changes the relative spacing between the magnet in relation to the sensor. The output in turn is proportional to the spring force and other parameters of the force sensor.

Prior art force sensors such as the above are characterized by output accuracy and production calibration difficulties. The performance of the prior art sensor will vary in correspondence with the mechanical tolerance stack-up across the spring length, housing dimensionality including the size of the housing opening, sliding plate opening, and spacers, which affect the relative placement of the magnet and sensor. Additionally, the output signal will vary with the magnetic field strength tolerance across one or multiple magnets. An added issue is one of output linearity due to magnet differences, mechanical structure and temperature effects.

It is an object of the present invention to provide a force sensor with means for compensation for the variance in component tolerances.

Accordingly the invention comprises: a force or tension sensor comprising: relatively movable first and second pieces, the pieces movable between a first position to a second position, at least one of the pieces operatively connected to a seat belt; spring means for biasing the first and second pieces to the first position; one or more magnets located on and movable with one of the first and second pieces (or alternatively the magnetic sensor can be so movable), the magnetic generates a magnetic field; sensor means responsive to changes in the magnetic field resulting from the relative motion of the pieces for generating an output signal indicative thereof; compensating means for compensating for variances in the mechanical and magnetic properties from respective nominal operating parameters and for causing the output signal to more closely correspond with a desired signature irrespective of these variances.

Many other objects and purposes of the invention will be clear from the following detailed description of the drawings.

### BRIEF DESCRIPTION OF THE DRAWINGS

FIG. 1 is a schematic representation of a child car seat installed in a vehicle together with the seat belt force or tension sensor of this invention and a schematic of the air bag and air bag deployment system.

FIG. 2 is a front plan view, partially broken away in cross-section, of the seat belt force sensor of FIG. 1.

FIG. 3 is an exploded isometric view, partially broken away in section, of the seat belt tension sensor of FIG. 1.

FIG. 4 diagrammatically shows the operation of the present invention

### DETAILED DESCRIPTION OF THE DRAWINGS

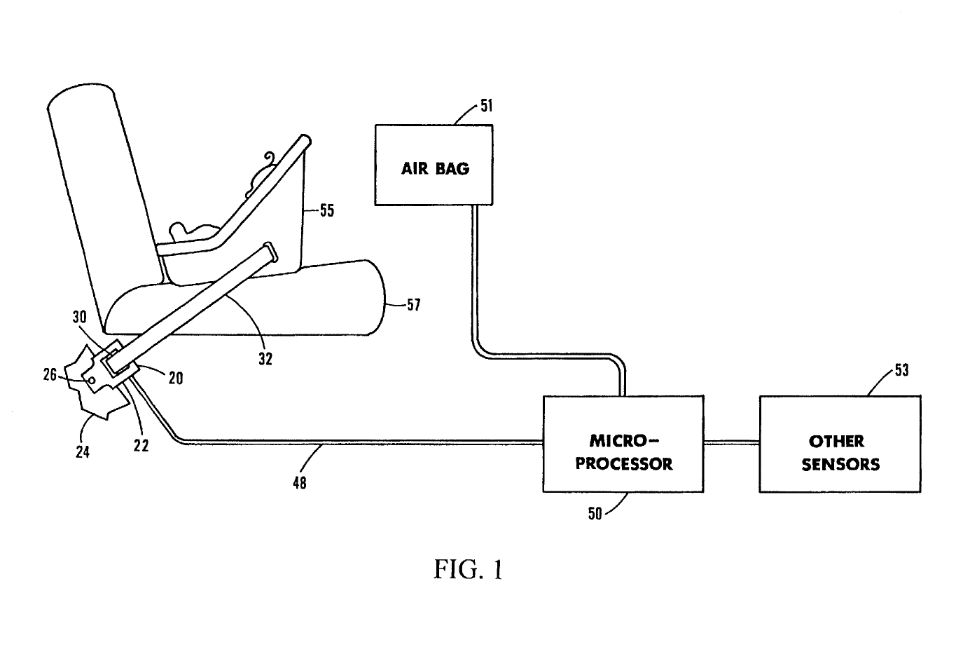

FIGS. 1-3 show an exemplary seat belt tension sensor FIG. 4 diagrammatically describes the operation of the present system.

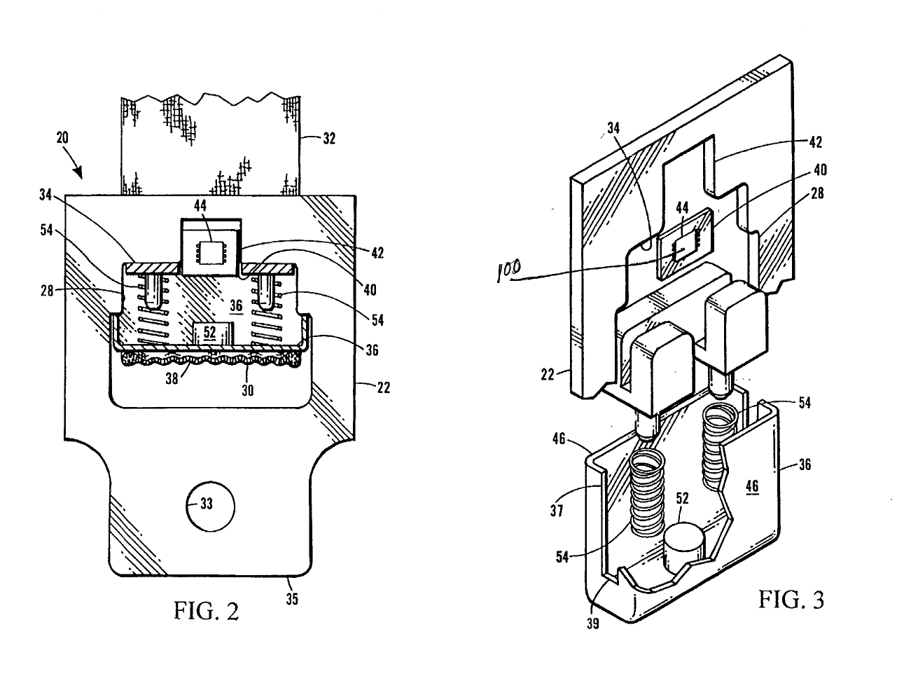

FIGS. 1-3 show a seat belt tension sensor 20 fixed to a seat belt anchor bracket 22. One such tension sensor is shown in U.S. Pat. No. 6,081,759, which is incorporated herein by reference. As best shown in FIG. 1, the anchor bracket 22 is mounted to a structural component 24 of a vehicle (such as the floor, or seat frame or vehicle pillar) by a fastener such as bolt 26. The anchor bracket 22, as shown in FIG. 2, has an opening 28 through which a loop 30 of a seat belt 32 passes. A hole 33 is formed in the lower portion 35 of the anchor bracket 22 through which the bolt 26 passes.

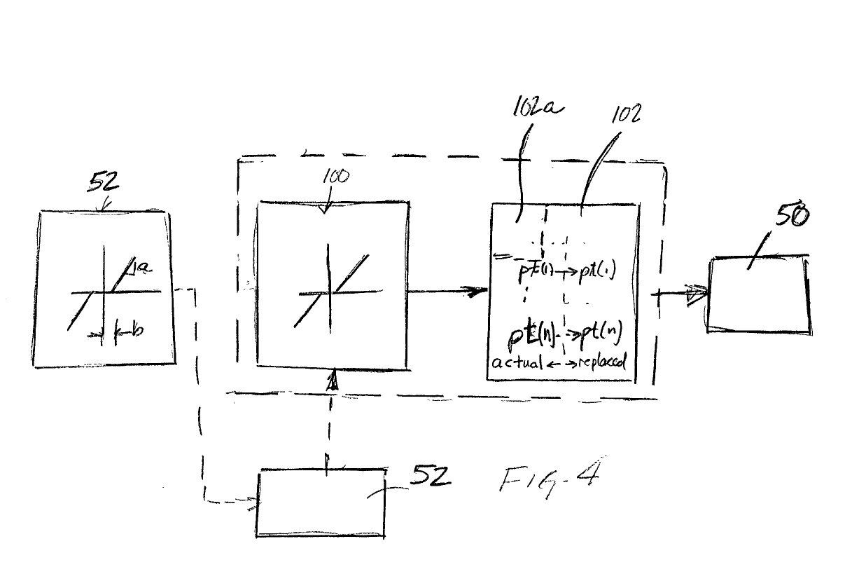

The seat belt loop 30 connects the seat belt 32 to the anchor bracket 22. When a force or tension is applied to the seat belt 32 the loop 30 is pulled toward the top side 34, or seat belt restraining side, of the opening 28 in the anchor bracket 22. As shown in FIGS. 2 and 3, a sliding carriage 36 is positioned between the bottom 38 of the belt loop 30 and the top side 34 of the opening 28. The carriage 36 sides 46 have inwardly-turned edges 37, which guide the motion of the carriage 36 along the bracket 22. Reduced height end wall stops 39 are formed between the edges 37. The stops 39 serve to limit travel of the carriage 36. A circuit board 40 can be mounted in a rectangular notch 42 in the top side 34 of the bracket 22. The circuit board 40 contains an integrated circuit chip 44, which incorporates a magnetically responsive sensor 100, such as a Hall effect or GMR sensor, or other like-operating sensor. Alternatively only the magnetic sensor 100 can be located on the force sensor 20.

As shown in FIG. 1, the magnetic sensor 100 within is connected by wire leads 48 to a microprocessor 50. The microprocessor 50 is connected to an air bag 51 and other sensors 53. The air bag 51 is positioned with respect to a particular passenger seat 57 on which a passenger or a child car seat 55 is restrained by the seat belt 32. The decision to deploy an air bag is made by the microprocessor 50. The deployment decision is based on logic that considers the acceleration of a crash as detected by one or more crash sensors. Other criteria can include crash severity and data indicative of whether the front seat is occupied by a passenger who would benefit from the deployment of the air bag 51. Sensors, which determine the weight of the occupant, the size of the occupant and the location of the seat have been developed. The seat belt force or tension sensor 20 supplies an important piece of information, which can be considered by the microprocessor logic alone or with other data to reach a conclusion about the desirability of employing an air bag in a particular situation.

As shown in FIG. 3, the magnetic sensor 100 responds to a field produced by magnet (or magnets) 52, which is affixed to the bottom of the U-shaped sliding carriage 36. When a force or tension is applied to the seat belt 32 it draws the carriage 36 against springs 54 toward the top side 34 of the opening 28 where the magnetic sensor 100 is mounted. The magnetic sensor 100 responds to the intensity of the magnetic field, which reaches the sensor 100. The sensor 100 has a response, which varies as belt tension draws the carriage 36 and the magnet 52 toward the sensor 100. The magnetic field present at the sensor is thus correlatable with belt tension by the microprocessor 50.

Reference is again made to FIG. 4, which shows a representative magnetic sensor 100 in proximity to a magnet 52. In one embodiment the sensor 100 can be a standard magnetic sensor such as a Hall effect or GMR (magneto resistive) sensor, or some other magnetic sensor. As mentioned above, the sensor 100 will generate a signal responsive to the strength of the magnetic field. A spring 54 is diagrammatically shown connected to the magnet 52 and is representative of the various component variances and tolerances from a nominal condition that can affect the output generated by the magnetic sensor 100. As mentioned above, the output of the magnetic sensor 100 will vary from its designed output because of many other parameters. In order to compensate for these parameter changes the output of the magnetic sensor is communicated to an Electronic Calibration Module 102 (ECM), which is useful in eliminating or greatly reducing the deficiencies found in the prior art. The ECM 102 allows for the calibration and storage of critical parameters for each individual seat belt force sensor 20 during the production process.

The ECM 102 can be part of the sensor 100 or implemented on a separate circuit board, or the functions of the ECM can be incorporated within the microprocessor 50. The ECM 102 comprises a programming protocol and non-volatile memory for parameter retention. Alternatively, the ECM 102 can be implemented as a stand-alone programmable magnetic sensor (programmable Hall effect sensor) such as the Micronas HAL 815. The electronic calibration is independent of sensor type.

As can be appreciated, the output of the sensor 100 will vary with, for example, the physical characteristics of the spring or springs 54, by the magnetic characteristics of magnet 52 and the stack-up of tolerances of the various components, and the variable sizes of various components of the force sensor 20. As shown in FIG. 4, the output of the spring 54 and hence the relative movement between the magnet 52 and the sensor 100 can vary with the spring constant A, as well as its dead zone B of the spring. Even with a thoughtful selection and careful design, tolerances will vary spring-to-spring in a production environment. Similarly, the magnetic characteristics of the magnet 52 will vary from magnet to magnet.

In the present system, the output characteristics of the sensor 100 are modified by the ECM 102 to compensate for the variability of the physical, mechanical and magnetic components of each force or tension sensor 20.

The sensor 100 and the ECM 102 communicate with a microprocessor 50, which may be shared with other safety and vehicular systems. System design will impose a predetermined protocol on the output of the sensor 100, ECM 102 and one that is anticipated by the microprocessor 50. For example, X volts (or amps) of output should correspond to a sensed force or tension of Y Newtons (pounds). For example, it would not be uncommon to specify the output of the magnetic sensor 100 to be in the range of the 1 volt to 4 volts corresponding linearly to an applied force in the range of 0 N to 111 N (25 pounds).

Due to the above-mentioned component variances, the output of sensor 100 will not always correspond to the designed output. The following procedure can be used to nullify the effect of dimensional and other differences across various mechanical components and also eliminate the effect of magnetic field strength tolerances. To achieve this desired result a table can be created in the storage memory 102a of the ECM 102, which maps or replaces the actual output voltage of sensor 100 to a known applied force across the force sensor 20 with the desired output signal at the applied force level. The values in memory can be referred to as the stored or replaced output signal of the sensor 100. As can be appreciated, at least two measurements are desirable. The programmable aspect of the ECM 102 permits each stored output signal to be interrogated, replaced, modified, and/or scaled or further compensated (such as for temperature variations, for example using a three dimensional table of values) so that the effective output signal communicated to the microprocessor corresponds to the desired output signal or transfer function of the force sensor 20. The ECM 102 allows selection of the output signal range and provides a means for linearization of the signal and temperature compensation if desired. The following is a simplified example of a method to calibrate a particular force sensor 20. The force sensor 20 is subjected to a sample force at or near the maximum applied force, for example 111 N. The sensor is also subjected to a low-level applied force, for example 20N. If the tension sensor 20 were operating with ideal components, the output of the tension sensor when subjected to a force of 20 N and 111 N respectively would be approximately 1.54 volts and 4 volts, assuming the magnetic sensor 100 provided a linear output signal. The output of the physical sensor 100 is measured, interrogated and stored in the memory (which is part of the ECM 102). Upon measuring the output of the sensor 100, at each test point (which can be as many as practical), if the output is not the desired output, it is modified accordingly in the ECM 102 so that the effective output of sensor 100 corresponds to the desired level. Having defined at least two operating points, the operational range of the magnet sensor 100 is determined and the ECM 102 will provide a compensated output, which varies over the expected operating range of this sensor 100. A simple compensation scheme using two values of the stored output signal is used to determine the slope of transfer function of the sensor 100 that is, ΔV/Δ N. The desired slope of the sensor is known, that is 3V/111 N. If the determined slope varies from the desired slope, then during the operation of the sensor the actual output signal of the sensor 100 is multiplied by a scale factor to drive the effective output signal toward the desired output signal.

Many changes and modifications in the above-described embodiment of the invention can, of course, be carried out without departing from the scope thereof. Accordingly, that scope is intended to be limited only by the scope of the appended claims.

1. A seat belt force or tension sensor comprising
relatively movable first and second pieces, the pieces movable between a first position to a second position, at least one of the pieces operatively connected to a seat belt;
spring means for biasing the first and second pieces to the first position;
at least one magnet located on and movable with one of the first and second pieces, the magnet generating a magnetic field;
sensor means responsive to changes in the magnetic field resulting from the relative motion of the pieces for generating an output signal indicative thereof;
compensating means for compensating for variances, from a nominal condition, of the component parts of the force sensor including variances in the spring means and magnet from respective nominal operating parameters for causing the output signal to follow a desired signature irrespective of the variances of the spring means and magnet.

2. The tension sensor as defined in claim 1 wherein the sensor means includes a programmable Hall effect sensor.

3. The tension sensor as defined in claim 1 wherein the compensating means is apart from the sensor means.

4. A method of operating a tension sensor of the type defined in claim 1, the method including the following steps:
a) subjecting the sensor to a known first force and determining a corresponding first output signal;
b) comparing the first output signal to a desired or theoretical first output signal and replacing the first output signal with the desired or theoretical first output signal;
c) subjecting the sensor to a known second force and determining a corresponding second output signal;
d) comparing the second output signal to a desired or theoretical second output signal and replacing the first output signal with the desired or theoretical second output signal;
e) using the replaced first and second signals to generate an output signal which is communicated to a command center.

5. The method as defined in claim 4 wherein the steps of comparing include storing the first and second output signals in a non-volatile memory.

6. The method as defined in claim 4 wherein the steps of comparing include storing the desired first and second output signals in a non-volatile memory.

7. The method as defined in claim 4 wherein the step of using includes the step of generating a linear output signal.
